(19) United States
(12) Patent Application Publication
(10) Pub. No.: US 2015/0096138 A1
(43) Pub. Date: Apr. 9, 2015

(54) ROCKER BRUSH ASSEMBLY

(71) Applicant: Habib Rostami, Irvine, CA (US)

(72) Inventor: Habib Rostami, Irvine, CA (US)

(21) Appl. No.: 14/048,031

(22) Filed: Oct. 7, 2013

(51) Int. Cl. B25G 1/10

(52) U.S. Cl. CPC B25G 1/10
USPC 15/145; 15/143.1

(57) ABSTRACT

An apparatus configured as a scrub brush having an ergonomic handle. The body of the handle is designed to move an upper elongate portion of the scrub brush to a vertical position in a ‘rocking’ motion. To move the head of the scrub brush above the body, the ‘rocker brush’ includes a stabilizing weight positioned within a cavity formed in a rounded bottom of the handle. The weight in the rounded bottom causes the scrub brush to ‘flip’ upwards in a rocking motion when a user sets the scrub brush on a flat surface, such as a kitchen or bathroom countertop.

### CROSS-REFERENCE TO RELATED APPLICATION

This application claims the benefit of U.S. Provisional Application Ser. No. 61/713,877, filed Oct. 15, 2012, the content of which is hereby incorporated herein by reference.

### BACKGROUND OF THE INVENTION

The present invention relates to the field of kitchen utensils. The present invention is more particularly directed to brushes and scrubbers with sponges for washing dishes or other household articles.

Currently, there exists a number of handheld brushes and scrubbers on the market that are used primarily for washing dishes or other household articles and items. These existing brushes and scrubbers typically include a handle for holding the unit and a sponge with or without an abrasive pad for scrubbing and washing dirty dishes.

A problem or shortcoming exists in the case of existing dishwashing brushes and scrubbers in that when the unit is not in use in the hands of the user, it has to be placed on a resting surface such as on a surface of the kitchen sink, on the kitchen counter or on some other substantially flat surface. In those instances, one problem is that the sponge, brush, or scrubbing surface of the unit typically comes in contact with the surface on which it rests, and that causes the other undesirable dirty surface that contains germs, bacteria, or other dirty particles to come into contact with and be passed onto the sponge, brush or scrubbing surface.

In view of the foregoing, there is a need for, and what was heretofore unavailable, a handheld brush, scrubber and/or sponge unit for use in washing dishes or other household objects is needed that is simple to use and that allows for placement of the unit at its base on a resting surface that can rock from side to side such that the unit can stand up on its own weight and avoid contact between the brush/scrubber/sponge portion and the resting surface, thereby preventing the passing of germs, bacteria or other dirty particles from between the resting surface and the brush/scrubber/sponge portion. The present invention fulfills these and other needs.

### SUMMARY OF THE INVENTION

Briefly, and in general terms, the present invention is directed to a utensil used for cleaning. The utensil is referred to as a ‘rocker brush’ because it is designed to move to a vertical position when laid flat on a surface, such as a kitchen countertop.

The rocker brush is configured with an upper elongate portion having a scrubbing device attached to the upper portion. The scrubbing device may be manufactured as an arcuate brush, an elongate brush, a scouring pad or other desired configurations. The rocker brush further includes a handle attached to the upper elongate portion. The upper the elongate portion may be removably attached to the handle portion by threads or other mechanisms. A stabilizing weight is positioned within a rounded bottom portion of the handle.

The stabilizing weight has a mass configured to move the elongate portion from a horizontal position relative to the handle portion to a vertical position relative to the handle portion. The stabilizing weight is positioned in a rounded pocket within the bottom of the handle. The handle bottom further includes a flattened portion in longitudinal registration with a central axis of the stabilizing weight.

The rocker brush handle may be formed with one or more reinforcing struts positioned within the handle. The handle body may be manufactured so that the stabilizing weight is positioned within a bottom cavity formed by a bottom portion of the handle body and a reinforcing strut. The handle body may be formed as two halves and joined together by sonic welding (ultrasonic, high frequency vibrations), thermal welding, chemical boding and other suitable processes. The two halves of rocker brush may be formed vertically (left and right) or horizontally (top and bottom) with the stabilizing weight positioned in the bottom portion of the handle body.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a front plan view of an embodiment a rocker brush of the present invention.

FIG. 2 is a rear plan view of an embodiment a rocker brush of the present invention.

FIG. 3 is a side plan view of an embodiment a rocker brush of the present invention.

FIG. 4 is bottom perspective view of an embodiment a rocker brush of the present invention.

FIG. 5 is a side perspective view of an embodiment a rocker brush of the present invention.

FIG. 6 is a top perspective view of an embodiment the rocker brush in accordance with the present invention, wherein the top portion is disconnected from the bottom portion.

FIG. 7A is a side plan view of an alternative embodiment a rocker brush of the present invention.

FIG. 7B is a side plan view of an alternative embodiment a rocker brush of the present invention.

FIG. 8 is a side perspective view in partial cross-section of a body of a rocker brush in accordance with the present invention taken along line 8-8 of FIG. 5.

FIG. 9 is a perspective view of a stabilizing weight of the present invention.

FIG. 10 is a side plan view of a rocker brush of the present invention depicting component dimensions.

FIG. 11A is a schematic representation of a rocker brush of the present invention depicting component dimensions and weight vectors.

FIG. 11B is an equation for calculating the mass of a stabilizing weight in accordance with the present invention using the component dimensions shown in FIG. 11A.

### DETAILED DESCRIPTION OF THE INVENTION

As shown in the drawings for purposes of illustration, the present invention is directed to a kitchen utensil. The present invention is further directed to a scrub brush having an ergonomic handle. The body of the handle is configured to move an upper elongate portion of the scrub brush when paced in a horizontal position to a vertical position in a ‘rocking’ motion. To move the head of the scrub brush above the body, the ‘rocker brush’ includes a stabilizing weight positioned within a cavity in a rounded lower portion (bottom) of the body that is used as a handle. The weight in the rounded bottom causes the scrub brush to ‘flip’ upwards in a rocking motion when a user sets the scrub brush on a flat surface, such as a kitchen or bathroom countertop.

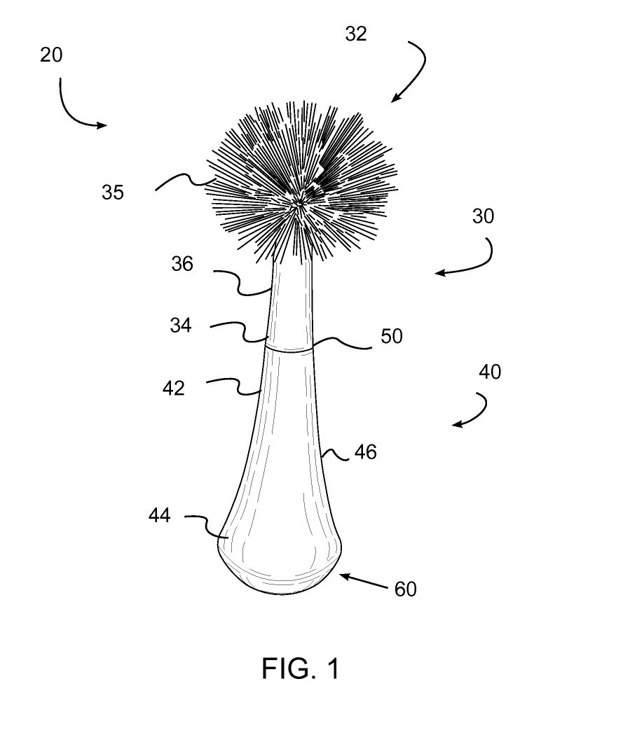

Turning now to the drawings, in which like reference numerals represent like or corresponding aspects of the drawings, and with particular reference to FIGS. 1-3 a rocker brush 20 of the present invention is shown having an elongate (upper) portion 30, and a body (handle) portion 40, which is formed with a rounded bottom 60. Although the rocker brush may be held or positioned at any angle, the terms “top”, middle” and “bottom” are in reference to the rocker brush when it is resting upright on a flat surface.

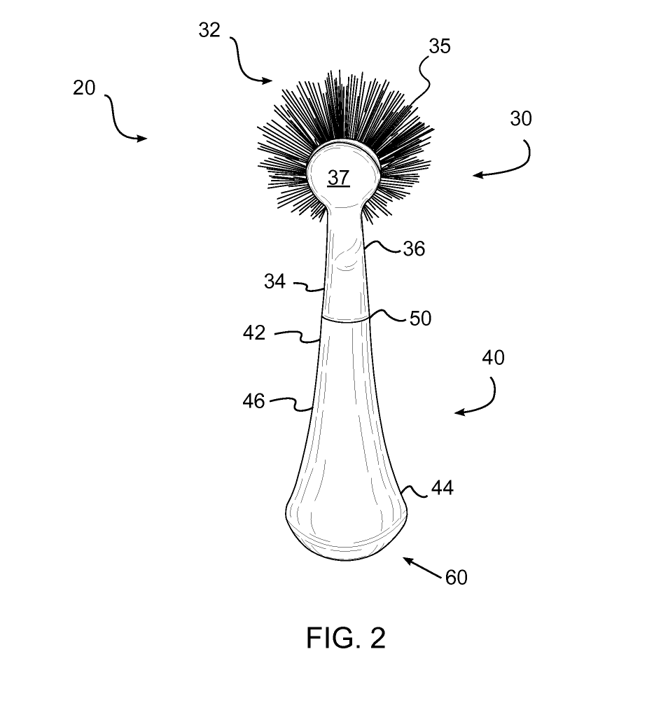

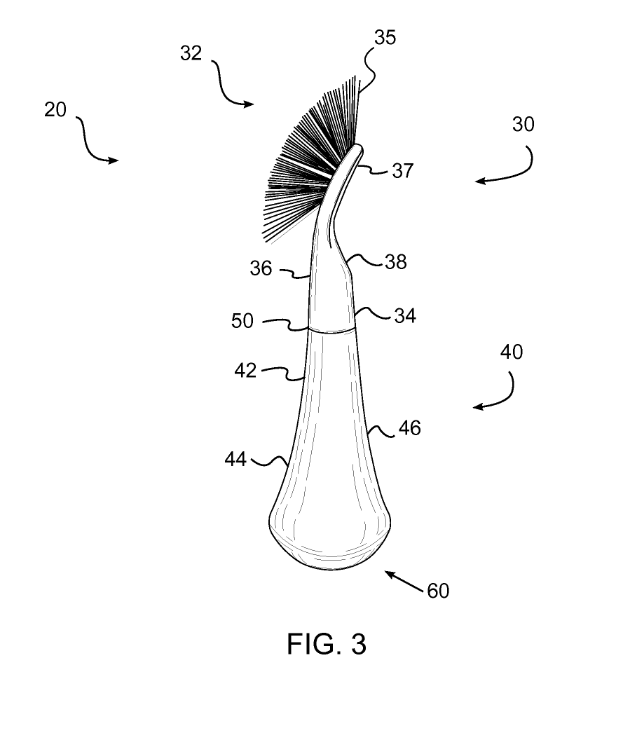

Referring again to FIGS. 1-3, the rocker brush 20 is formed with an upper portion 30 having a top portion 32, a bottom portion 34 and a middle portion 36. The top, middle and bottom portions of the upper elongate portion may have any suitable shape for enhancing a scrubbing action of the rocker brush. For example, a scrub brush 35 may be attached to a relatively flat surface 37 (see FIGS. 2 and 3) of the top portion of the rocker brush. A transition section 38 may be tapered or otherwise suitably shaped to efficiently impart force from the handle 40 to the scrub brush. The bottom section 34 of the elongate portion of the rocker brush may be generally cylindrical, and may taper to a larger diameter from the transition section so as to have substantially the same diameter as the upper portion 42 of the handle.

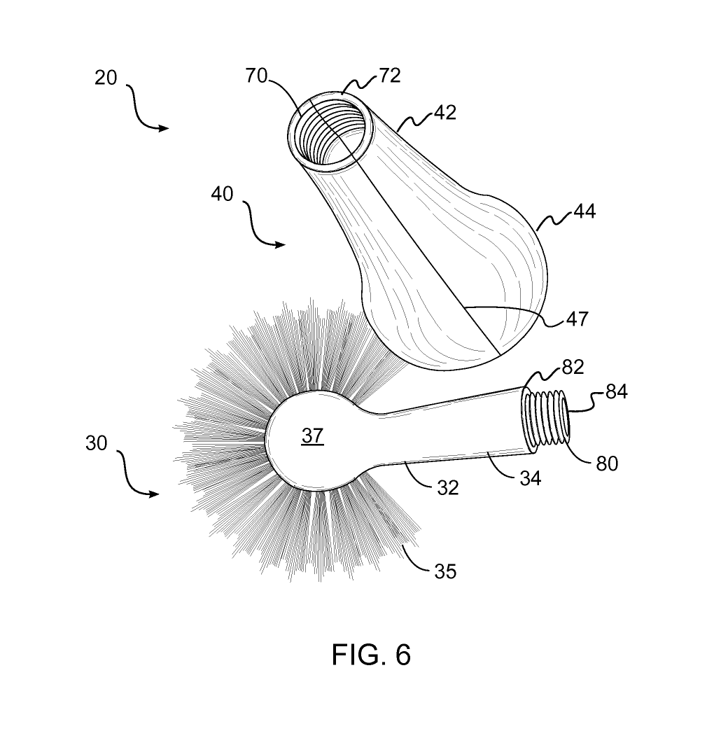

As shown in FIGS. 1-3, the upper section 30 may be configured to detach from the body section (handle) 40 (see FIG. 6). To provide continuity and force from the handle to the scrub brush 35, the bottom portion 34 of the upper section may be configured with about the same diameter as the upper portion 42 of the handle. As is known to one of ordinary skill in the art of making kitchen or similar utensils, a substantially watertight seal may be formed at the juncture 50 of the two portions of the rocker brush. Alternatively, the elongate portion and handle may be formed as one part. The upper section and body of the rocker brush may be manufactured using casting techniques, injection molding, sonic welding, bonding with glue or other adhesives and any other techniques now known or available in the future to those of ordinary skill in the art.

Referring again to FIGS. 1-3, one embodiment of the lower portion 40 of the rocker brush 20 is formed with a body that creates an ergonomic handle. The upper portion 42 of the body is generally cylindrical and tapered to provide a smooth juncture 50 against the bottom portion 34 of the elongate portion 30 of the rocker brush. The diameter of the upper portion of the handle body is designed so that rocker brush can be easily grasped by the fingers of a user. In particular, the index and/or middle finger of the hand can be used to impart a strong force on the upper end 32 of the elongate portion and thereby onto the scrub brush 35. Similarly, the fingers may be used to easily and vigorously move the scrub brush in various cleaning motions, for example, up/down and side-to-side. The middle portion 46 of the handle body is again generally cylindrical, but is wider than the upper portion of the body so that the handle fits snugly (conforms) to the palm of the user's hand. For even a stronger grip, the cylindrical handle bottom portion 44 may be wider than the middle portion to provide a firm grip for the user. As shown for references purpose only, and is not intended to be limiting, the rocker brush body has a gradual and arcuate (partial circle) taper from the top to the bottom of the handle.

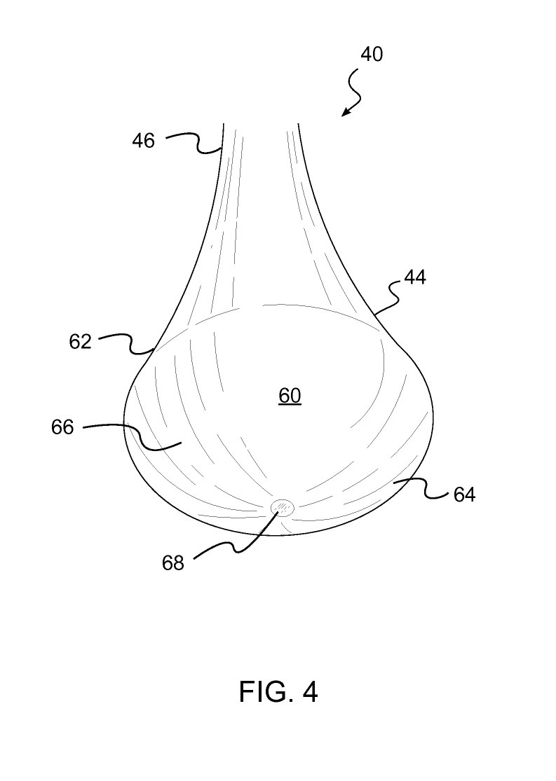

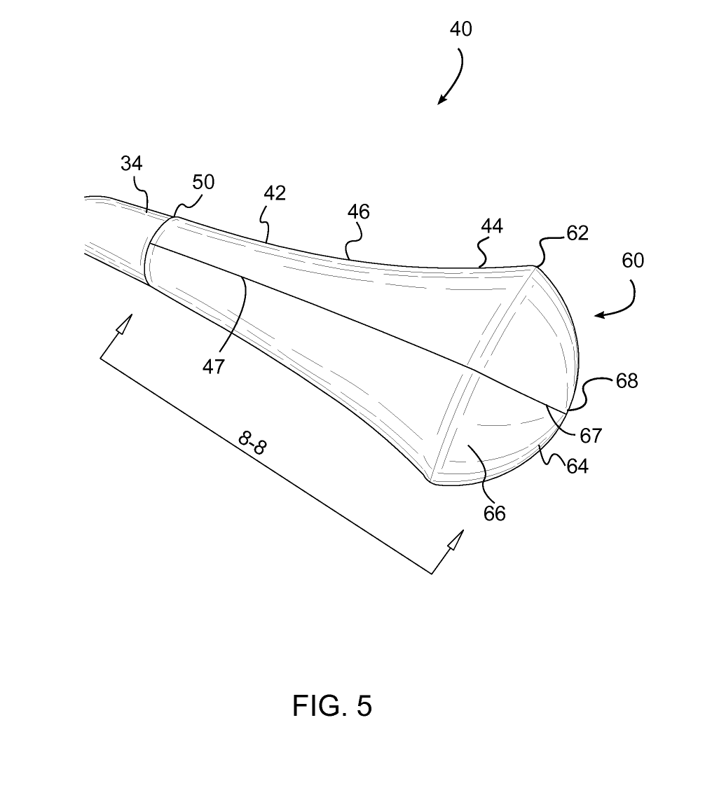

As shown in FIGS. 4 and 5, the body 40 of the rocker brush is configured with a cylindrical and tapered bottom 60. The tapered bottom starts at a section or edge 62 contiguous with the bottom portion 44 of the handle body. The lower portion 64 of the bottom of the handle is flatter (less steep) than the middle portion 66 of the handle bottom. In one embodiment of the handle bottom portion, the very bottom 68 (point farthest from the scrub brush 35) is flattened so that the rocker brush rests upright when the elongate portion 30 and scrub brush are vertically above the handle (see FIGS. 1-3, 7A and 7B). Without undue experimentation, the length, diameter and curvature of the body and the bottom portion of the handle may be configured for stability (movement from a substantially horizontal position to a vertical position) and for increasing the look, feel and utility of the handle.

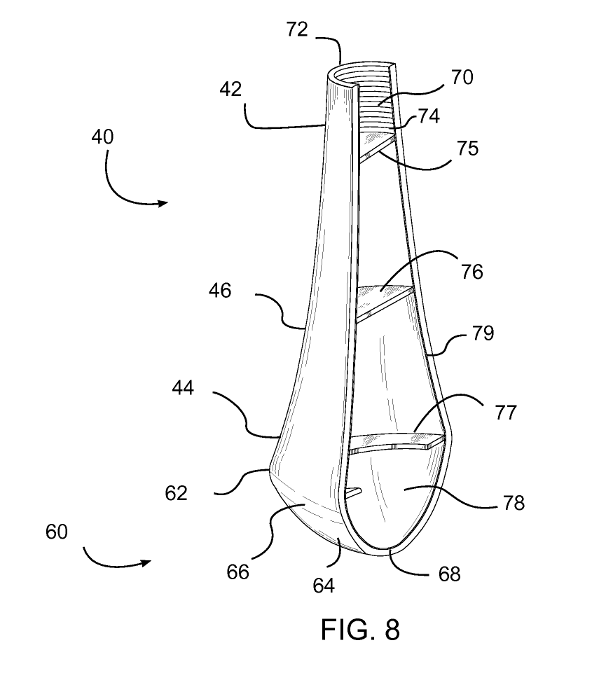

Referring now to FIG. 6, one embodiment of the rocker brush 20 is configured so that the upper elongate portion 30 having the scrub brush 35 is detachable from the lower body 40 that forms the handle of the apparatus. The top portion 42 of the handle includes a set of threads 70 that begins at the utmost top 72 of the handle and extends downward within a cylindrical cavity in the body. The end of the threads 74 (see FIG. 8) may be configured within the upper portion of the body so as to allow the body to curve outward toward its bottom portion 44.

As shown in FIG. 6, the elongate upper portion 30 of the rocker brush 20 may include a set of threads 80 starting proximate the end 82 of the bottom portion 34 of the scrubber. The threads extend a sufficient length from the elongate portion so as to have an end point 84 that provides a set of threads substantially the same length as the set of threads 70 in the handle body 40. The length of threads in the scrub brush portion may be shorter than the length of threads in the body so long as the upper and bottom portions of the rocker brush are firmly secured. Likewise, the upper and bottom portions should be joined to provide an essentially watertight seal at the juncture 50 of the two portions of the rocker brush (see FIGS. 1-3, 7A and 7B). Alternatively, the upper and bottom portions of the rocker brush may be secured by other mechanisms known to those of ordinary skill in the art, such as a press fit, snap locks, pin and slot devices, and bonding materials.

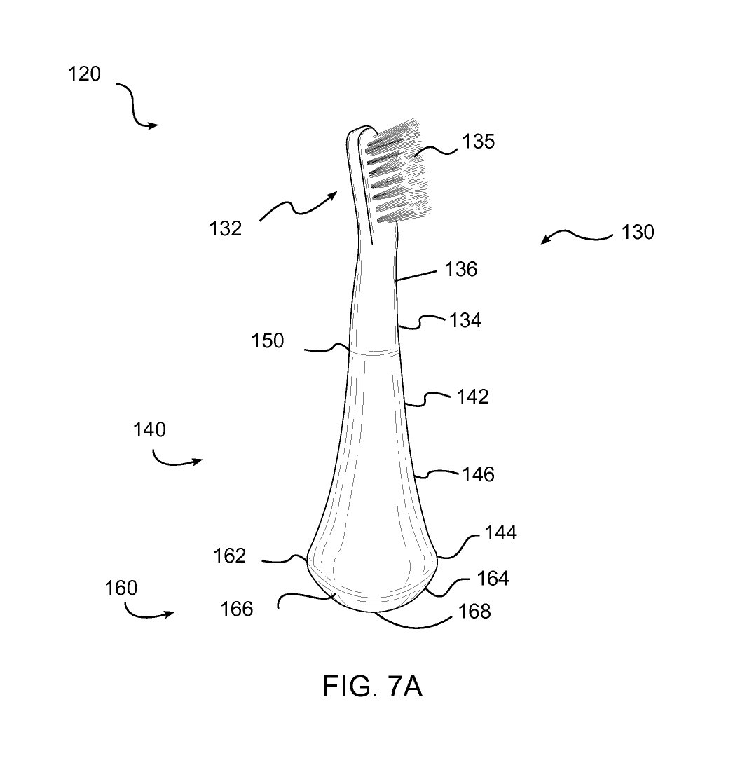

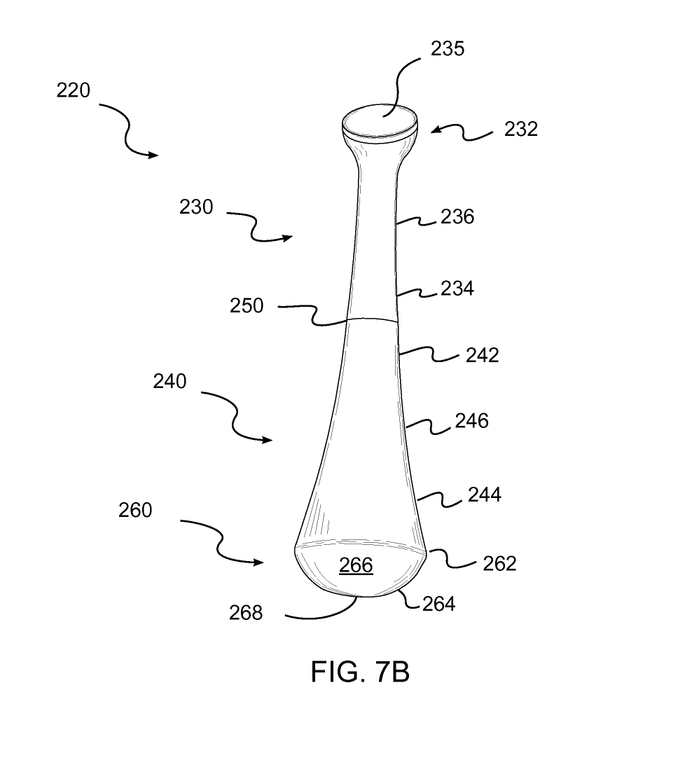

Alternative embodiments of the circular scrub brush 35 shown in FIGS. 1-3 and 6 secured to the elongate upper portion 30 of the rocker brush are contemplated in accordance with the present invention. For example, as shown in FIG. 7A, a rectangular head 135 is attached to the top end 132 of the upper portion 130 of the rocker brush 120. In FIG. 7B, a circular or oval head 235 is attached to the top end 232 of the upper portion 230 of the rocker brush 220. The length of the end portions (134, 234) and middle portions (136, 236) of the scrubbing portion may be configured to provide appropriate leverage to the brush or pad. For example, the overall length may be shorter to impart more force to a grout brush and longer for a scouring pad used on deep pots and pans. Similarly, the body (140, 240) may have longer or shorter top (142, 242), middle (146, 246) and bottom (144, 244) portions. In addition the rocker portion 160, 260 may have a wider or narrower upper (162, 262), middle (166, 266) and bottom (164, 264) portions. Furthermore, the resting pad 168, 268 may be larger or smaller in diameter to accommodate the dimensions of the overall rocker brush configuration.

The scrub brush heads may be made of any suitable material for the desired function of the rocker brush. For example, polymers, plastics, rubber, metals and composite materials may be used. More specifically, polypropylene, polycarbonates, polyurethanes, acrylics, vinyls, Nylon, poly-methyl mythacrylate (PMMA), acrylonitrile butadiene styrene (ABS), methylmethacrylate-styrene (MS) and polyethylene terephthalate (PET) are known materials that can may be used by one of ordinary skill in the art to form the brush material. In addition, a particular brush design may be made of more than one material. As contemplated within the scope of the present invention the circular brush shown in FIG. 1 may be formed with harder (stiffer) bristles in the middle than on the outside. Similarly, the grout type brush shown in FIG. 7A may include softer, longer bristles in the center, stiffer bristles in the middle and a third type of bristle on the edges. The bristles and pads may be colored to indicate the abrasiveness or strength of the materials used in the scrub brush.

The SCOTCH-BRITE synthetic scouring pad material available from 3M of St. Paul, Minn. (spun polypropylene fibers containing aluminum oxide) may especially useful for attaching to the scrub brush pad 235 depicted the design shown in FIG. 7B. Alternatively, a soft sponge material may be attached to that scrub brush pad. The scrub brush pad and/or material may be configured so that the scrubbing device is removably attached to the scrub brush pad.

The rocker brush body (handle) may also be formed of any suitable materials depending upon the function of the apparatus. The materials listed herein regarding the bristle brushes may also be engineered by one of ordinary skill in the art without undue experimentation to form the rocker brush handle. For example, moldable and extrusion plastics, thermoplastics, rubber, metals, wood and composites may be used to form the handle. Thermoplastics (for example Nylon and polypropylene) are known materials that can be used to form two handle body halves configured to be joined using sonic or thermal (heat) welding.

Referring now to FIG. 8, one embodiment of the body 40 of the rocker brush is manufactured from a two-part shell that is joined to form a single handle having a circumferential seam 47, 67 (see FIGS. 5 and 6). Each half of the shell includes a top portion, including threads 70 that begin at an upper edge 72 of the shell. In an embodiment of the present invention, each half of the body includes a first reinforcing strut 75 positioned in the top section of the body just below the ending point 74 of the threads. Each reinforcing strut 75 may be configured with an overlapping flange to avoid fluid leakage into the top portion 42 of the handle 40 from the juncture 50 with the upper elongate portion 30.

A second reinforcing strut 76 is positioned in the middle portion 46 of each half of the handle body 40. Each half of both the top reinforcing struts 75 and middle reinforcing struts 76 are semicircular in shape so that the two halves form a flat circular disk when the two halves of the handle body are joined together. These struts give the handle ‘hoop strength’ to prevent the handle body from collapsing then grasped by the user. The top reinforcing struts also provide longitudinal strength and help distribute the scrubbing force when the handle is joined to the elongate portion 30 having the scrub brush head 35 (FIGS. 1-3).

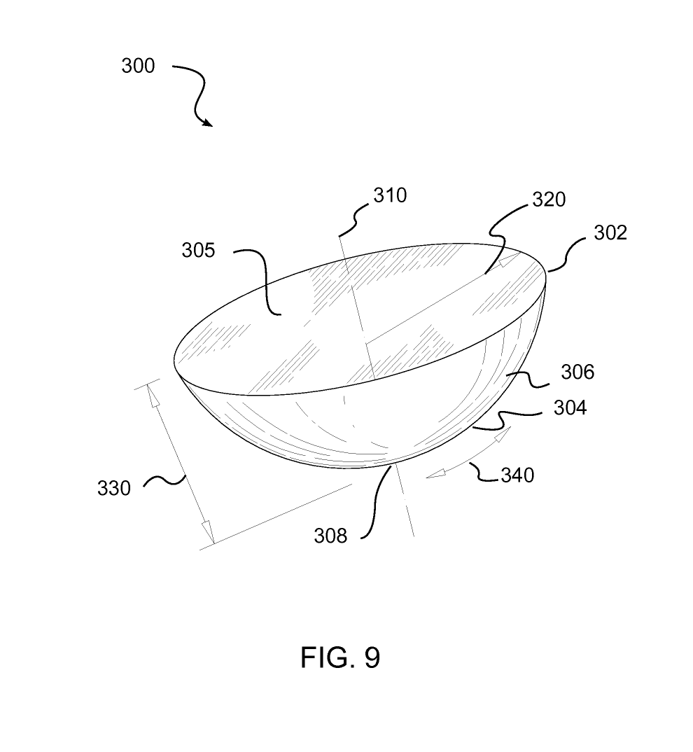

Referring again to FIG. 8, the rounded bottom portion 60 of the handle 40 includes a third reinforcing strut 77 in the lower portion 44 of the handle body and at the top edge 62 of the rounded bottom portion. Each half of the third reinforcing strut is “C” shaped—semicircular with a central semicircular cutout. Thus, when the two halves of the third reinforcing strut are joined they form an “O” shaped disk (toroidal, or ‘doughnut’ shape). The combined halves of the third reinforcing strut and the wall of the middle portion 66 of the rounded bottom portion of the body form a cavity 78 for retaining a stabilizing weight (see FIG. 9). The two halves of rocker brush may be formed vertically (left and right) or horizontally (top and bottom) with the stabilizing weight positioned in the bottom portion of the handle body.

As shown in FIG. 9, the stabilizing weight 300 is provided to give weight to the bottom portion of the handle body of the rocker brush. The stabilizing weight need not have any particular shape, but should conform to the design of the rocker brush handle. For example, to properly fit within the cavity 78 of the bottom portion 60 of the handle 40 shown in FIG. 8, the stabilizing weight is formed with a flat upper surface 305 and rounded outer sides 306 that are positioned against the middle portion 66 of the handle bottom. The top portion 302 of the stabilizing weight is positioned adjacent the top portion 62 of the rounded handle bottom. The bottom portion 304 of the stabilizing weight is positioned adjacent the arcuate wall 64 of the handle bottom, so that the ultimate bottom 308 of the stabilizing weight rests against the flat portion 68 of the handle bottom that provides a platform for the rocker brush when standing vertical.

A centerline 310 of the stabilizing weight 300 is shown FIG. 9. The radius 320 of the upper portion surface 305 is chosen to accommodate the internal diameter of the cavity 78 at the upper edge 62 of the rounded bottom portion 60 of the rocker brush handle 40 (see FIGS. 4, 5 and 8). The height 330 of the stabilizing weight is chosen to fit between the third reinforcing strut 77 (if provided as shown in FIG. 8) and/or the upper edge 62 of the rounded bottom portion of the rocker brush handle. The curvature 340 of the stabilizing weight is chosen to coincide with the curvature of the middle portion 66 of the rocker brush handle.

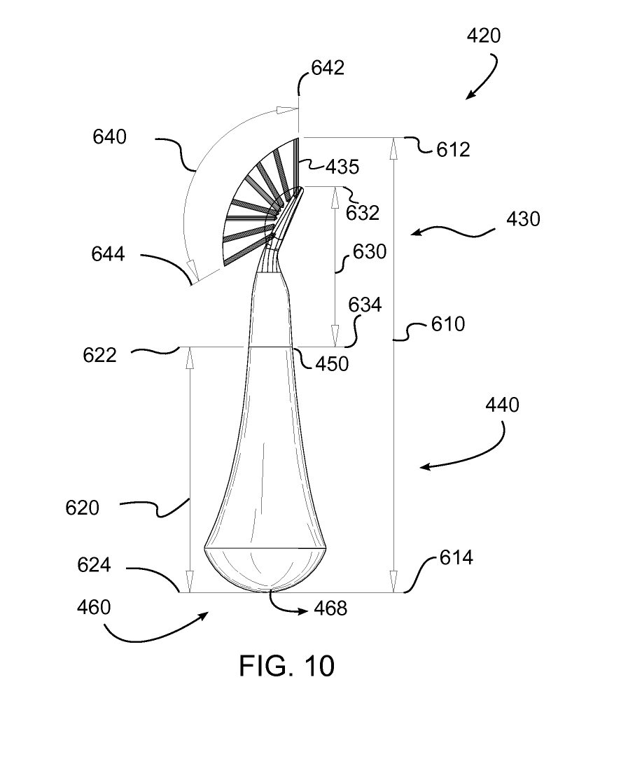

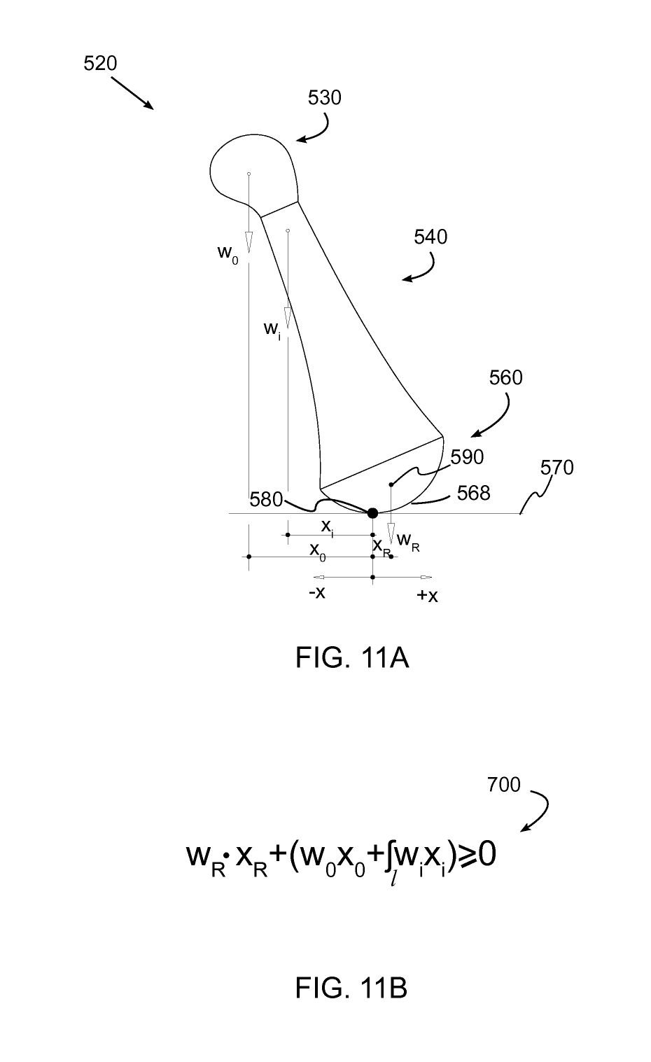

For a rocker brush designed for use in an adult human hand and formed from a thermoplastic (for example, Nylon or polypropylene), having the height dimensions shown in FIG. 10 and using the calculations shown in FIG. 11A and 11B, the diameter of the stabilizing weight 300 is about fifty (50) millimeters and the height 330 of the stabilizing weight is about eighteen (specifically 18.2) millimeters. Using the dimensions from FIGS. 10, 11A and 11B, the calculated ‘mass’ of the stabilizing weight is one hundred and sixty-five (165) grams. The dimensions recited herein can be adjusted without undue experimentation by one of ordinary skill in the art using the schematic and calculations shown in FIGS. 11A and 11B.

The stabilizing weight may be made from suitable metals (for example, stainless steel, tin and iron), high-density plastics and composite materials (for example, plastic or rubber embedded with metal shot) that are applicable for kitchen utensils. Stainless steel is particularly useful for its anti-corrosion (oxidation resistant) properties when the rocker brush is used with water, detergents and corrosive solvents. The stabilizing weight may be formed as a sold body or a an empty shell, so long as the weight and center of gravity conditions set forth in FIGS. 11A and 11B are satisfied.

Referring now to FIG. 10, one embodiment of the rocker brush 420 is configured with ergonomic dimensions for use in an adult human hand. The height 610 of the combined upper elongate portion 430 and handle body 440 is about two hundred and eight (specifically, 208.83) millimeters, when measured from the top 412 of the arcuate scrub brush 435 to the lowest end 614 of the rocker brush at the flat resting section 468 of the handle bottom portion 460. The height 620 of the body handle is about one hundred and ten (specifically, 112.8) millimeters, when measured from its top 622 at the juncture 450 with the upper elongate portion down to its lowest end 624 at the flat resting section of the handle bottom portion. The height 630 of the upper elongate portion is about eighty-eight (specifically, 88.74) millimeters, when measured from its uppermost tip 632 down to its lowest point 634 at the juncture with the handle body. The arc (angle) 640 of the depicted scrub brush is about one hundred and twenty degrees, when measured from the uppermost bristle 642 to the bottom bristle 644. The disclosed dimensions are by example only, and are not intended to be limiting, since other dimensions may be applicable for other rocker brushes, see FIGS. 7A and 7B.

FIGS. 11A and 11B provide a schematic of the rocker brush 520 and formula for calculation of the weight needed in the bottom portion 560 to counterbalance the combined weight of the upper portion 530 and the body portion 540. More specifically, the calculation of the stabilizing weight (see FIG. 9) is determined to effect the intended function of the having the rocker brush move from a substantially horizontal position (for example, thirty degrees) at the resting point 580 on a surface 570 (for example, a countertop) to a vertical position so that the rocker brush then rests (rocks back-and-forth) on the flat bottom portion 568.

In the schematic of FIG. 11A, the horizontal distance that the upper portion 530 of the rocker brush 520 moves is depicted by an arrowed line (−X to +X). The distance from where the bottom portion 560 of the handle body 540 is touching the surface 570 is shown as a resting point 580, which is the reference point for calculating the horizontal distances (X0, Xi) for each weight vector (W0, Wi). For purposes of calculating the bottom weight vector “WR” of the bottom portion 560 (including the stabilizing weight) at the center of gravity 590 of the rocker brush, the upper portion is given a single upper weight vector “W0” and a single upper distance “X0” from the resting point. The handle body, however, is assigned a plurality of body weight vectors “Wi”, each having a body distance “Xi”. Alternatively, the upper body also could be assigned a plurality of weight vectors and horizontal distances from the resting point.

The mass of the bottom portion 560 (substantially from the stabilizing weight—see FIG. 9) is calculated using the formula in FIG. 11B. The calculation includes a summation (sigma ∫) of a selected number of bodyweight vectors from “Wi” to “W|” multiplied by the distance “Xi” to “X|” of that weight vector from the resting point 580. The summation of the products of the body weight vectors and distances is added to the product of the single upper weight vector “W0” multiplied by the single upper distance “X0”. According to the calculation, the product of the bottom center of gravity weight vector “WR” multiplied by the distance “XR” from the resting point must be greater than the sum of the upper weight vector-distance product and the summation of each body weight vector-distance product. Calculating, measuring and/or estimating the center of gravity of the rocker brush, each weight vector and each distance of the weight vector from the resting point provides the basis for calculating the needed mass of the stabilizing weight.

Those skilled in the art of manufacturing mechanical devices such as the disclosed kitchen utensil can determine, without undue experimentation, the appropriate dimensions, geometries, materials, and other features of the upper elongate portion and scrub brush. Similarly, those skilled in the art can determine, without undue experimentation, the appropriate dimensions, geometries, materials and other features of the handle body of the device. Other embodiments in accordance with the present invention (for example, but not limited to, alternative scrubbing devices and stabilizing weights) may be employed as is known to those skilled in the art of designing and/or manufacturing of kitchen utensils. Similarly, those skilled in the art will understand from the disclosure herein that various modifications to the components of the rocker brush can be made without departing from the scope of the invention. More specifically, the present invention is not limited to any particular method of forming the elongate upper portion and the handle body of the rocker brush.

While certain aspects of the invention have been illustrated and described herein in terms of its use as a ‘scrub brush’ or ‘rocker brush’, modifications and improvements to the disclosed apparatus may be made without departing from the scope of the invention. Accordingly, the scope of the invention is not intended to be limited by, for example, but not limited to, the details of the drawings and the appended claims.

I claim:

1. An apparatus comprising:
an elongate portion having a first end, a second end and a middle portion formed between the first end and the second end;
a scrubbing device attached to the first end of the elongate portion;
a handle portion having a first handle portion, a second handle portion and a middle handle portion formed between the first handle portion and the second handle portion, wherein the second end of the elongate portion is attached to the first handle portion; and
a stabilizing weight positioned within the second handle portion.

2. The application of claim 1, wherein the second end of the elongate portion is removably attached to the first handle portion.

3. The apparatus of claim 2, wherein the first handle portion is configured with first threads and the second end of the elongate portion is configured with second threads.

4. The apparatus of claim 1, wherein the stabilizing weight has a mass configured to move the elongate portion from a horizontal position relative to the handle portion to a vertical position relative to the handle portion.

5. The apparatus of claim 4, wherein the second handle portion forms a rounded pocket for retaining the stabilizing weight.

6. The apparatus of claim 5, wherein the second handle portion further includes a flattened portion in longitudinal registration with a central axis of the stabilizing weight.

7. The apparatus of claim 1, wherein the scrubbing device is an arcuate brush.

8. The apparatus of claim 1, wherein the scrubbing device is an elongate brush.

9. The apparatus of claim 1, wherein the scrubbing device is a scouring pad.

10. The apparatus of claim 9, wherein the first end of the elongate portion is configured to accommodate a removable scrubbing device.

11. An apparatus comprising:
a body having an arcuate first body portion, and an arcuate second body portion,
wherein the first body portion is attached to the second body portion;
wherein the first body portion includes a first reinforcing strut positioned within the first body portion;
wherein the second body portion includes a second reinforcing strut positioned within the second body portion and having an outer edge configured to reside adjacent an outer edge of the first reinforcing strut; and
a stabilizing weight positioned within a bottom cavity formed by a first bottom portion of the first body portion and the first reinforcing strut, and further formed by a second bottom portion of the second body portion and the second reinforcing strut.

12. The apparatus of claim 11, further including an elongate portion having a first end and a second end, wherein the second end of the elongate portion is attached to the first body portion and to the second body portion.

13. The apparatus of claim 12, further including a scrubbing device attached to the first end of the elongate portion.

14. The apparatus of claim 13, further including:
first threads configured within the first body portion;
second threads configured within the second body portion; and
third threads configured at the second end of the elongate portion, wherein the third threads are configured to connect with the first threads and the second threads.

15. The apparatus of claim 14, further including:
a third reinforcing strut configured within the first body portion and positioned adjacent the first threads; and
a fourth reinforcing strut configured within the second body portion and positioned adjacent the second threads, wherein the third reinforcing strut has an outer edge configured to be positioned adjacent to an outer edge of the fourth reinforcing strut.

16. The apparatus of claim 15, wherein the body has a first diameter proximate where the first reinforcing strut is positioned adjacent the second reinforcing strut, wherein the body has a second diameter proximate where the third reinforcing strut is positioned adjacent the fourth reinforcing strut, such that the first diameter is greater than the second diameter.

17. The apparatus of claim 16, further including:
a fifth reinforcing strut configured within the third body portion being positioned between the first reinforcing strut and the third reinforcing strut; and
a sixth reinforcing strut configured within the third body portion being positioned between the first reinforcing strut and the third reinforcing strut and having an outer edge configured to be positioned adjacent to an outer edge of the fifth reinforcing strut.

18. The apparatus of claim 17, wherein the body portion has a third diameter proximate where the fifth reinforcing strut is positioned adjacent the sixth reinforcing strut, such that the third diameter is greater than the second diameter and the third diameter is less than the first diameter.
